(19) United States
(12) Patent Application Publication
(10) Pub. No.: US 2016/0266770 A1
(43) Pub. Date: Sep. 15, 2016

(54) MULTI-SELECTOR CONTEXTUAL ACTION PATHS

(71) Applicant: International Business Machines Corporation, Armonk, NY (US)

(72) Inventors: Ilse M. Breedvelt-Schouten, Ottawa (CA); Alireza Pourshahid, Ottawa (CA); Maria Gabriela Sanches, Ottawa (CA)

(21) Appl. No.: 14/645,334

(22) Filed: Mar. 11, 2015

(51) Int. Cl. G06F 3/0484; G06F 3/0488; G06F 3/01

(52) U.S. Cl. CPC G06F 3/04842; G06F 3/017; G06F 3/04883; G06F 3/04845

(57) ABSTRACT

An electronic device, computer implemented method and computer program product adapted to facilitate the management of and application of actions to objects displayed on the electronic device are disclosed. A wire metaphor, including so-called pass-through and lassoing techniques are used to illustrate the use of an uninterrupted gesture path to facilitate the contextual selection and application of a predefined action to associated target objects displayed on a mobile device that employs a touch screen user interface. Examples of such actions include grouping, moving, arranging, aligning, distributing, joining, and applying a theme to the selected target objects.

### BACKGROUND OF THE INVENTION

The invention relates generally to an interface to an electronic device and more specifically to a user interface of a mobile computing device. The popularity of mobile devices has resulted in the more frequent use of a “mobile-first” approach to the design of new software applications. The user interfaces of such electronic devices also use so-called “touch screens” and other interfaces to facilitate organizing, categorizing and/or managing actions applicable to objects, items and applications installed on the device. Marketplace forces have also resulted in mobile devices of decreasing size while the availability and use of such objects, items and applications (each typically represented by a graphical object displayed on the device display) has increased dramatically. Some touch screen models take the approach of expanding the number of unique input gestures to allow for a larger number of actions, while other approaches seek to constrain the number of unique gestures required through the use of multiple modes that allow a user to perform different actions with the same input gesture. There remains a need in the art for improvements in the application of an action to multiple objects displayed on an electronic device.

### SUMMARY

One embodiment of the present invention is a computer implemented method for contextually selecting target objects concurrently displayed on the display of an electronic device and applying an action to selected associated target objects via an uninterrupted input gesture path. The displayed objects include target objects associated with at least one predefined action which can be applied to one or more selected associated target objects. An example of a computer implemented method in accordance with the present invention commences upon the detection of an input to a first target object displayed on the electronic device. One or more action objects associated with the first target object are displayed in response to the selection of the first target object. In response to the detection and tracking of the input as an uninterrupted input gesture path that selects one of the displayed action objects, contextual feedback is provided to identify one or more other candidate target objects that can be associated with the displayed action object. The user can then continue the uninterrupted gesture path to select one or more of the other candidate target objects and the selection process can be completed by the detection of an interruption to the input gesture path, which in the application of the predefined action to the selected target objects.

In one embodiment, the electronic device is a mobile device with a touch-screen.

Another embodiment of the present invention is a computer program product with a computer readable storage medium and computer executable program code stored therein for contextually applying an action to objects concurrently displayed on the display of an electronic device.

Examples of predefined actions include grouping, moving, arranging, aligning, distributing, joining, and applying a theme to the selected target objects.

Examples of detecting and tracking the uninterrupted gesture path employ the use of wire metaphors, such as a “lassoing” technique to associate action objects with target objects, and a “pass-through” technique to facilitate the contextual selection and application of an action to target objects.

Examples of identifying one or more other candidate target objects include highlighting candidate target objects or conversely de-emphasizing e.g., by dimming or greying-out non applicable objects on the display.

In one embodiment, the one or more associated action objects can be initially displayed as generic shapes and additional feedback displayed upon the detection of a selection of an action object.

Further details of one or more aspects of the invention are set forth in or will be apparent from the Detailed Description, Claims and accompanying drawings.

### BRIEF DESCRIPTION OF THE DRAWINGS

FIG. 1 illustrates an example of electronic device in accordance with the present invention.

FIGS. 2A-2C illustrate examples of a computer implemented process in accordance with the present invention.

### DETAILED DESCRIPTION

By way of introduction, the following description will show various embodiments of the present invention facilitating the application of action(s) to multiple objects (e.g., icons, files, items, or targets) displayed on the screen of an electronic device. Conventional devices, components, techniques and other functional and individual components thereof that are understood by one of ordinary skill in the art may not be described in detail herein. On the other hand, specifics are in many cases provided merely for ease of explanation and/or understanding the various embodiments and possible variations thereof.

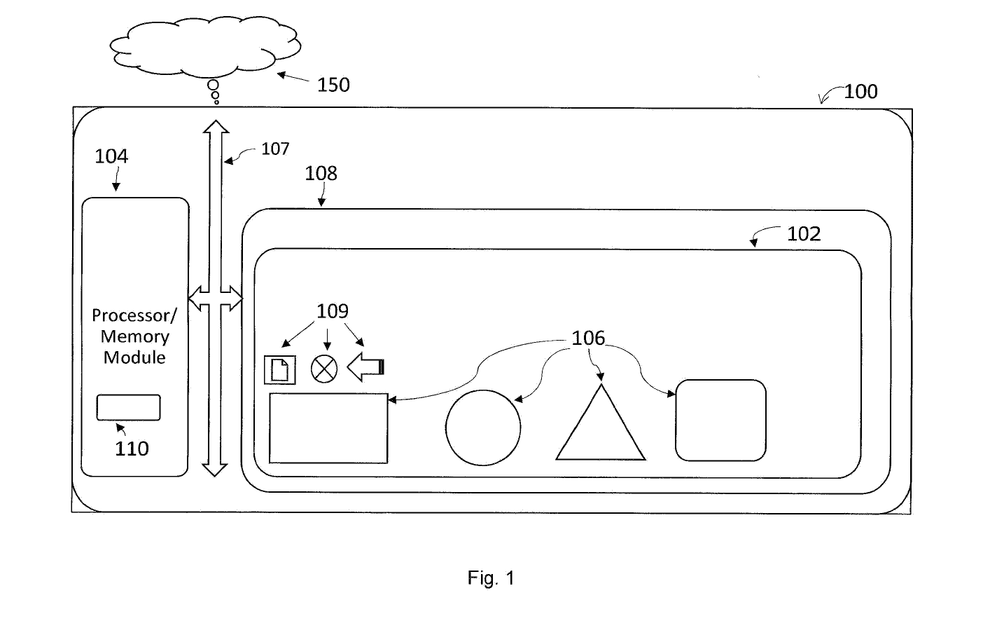

FIG. 1 depicts an example embodiment of the present invention on a mobile device. The mobile device 100 may be embodied, by way of example only, as one or more: mobile communications devices e.g., cellular phones, smart phones, personal digital assistants; computers e.g., servers, clients, laptops, tablets, notebooks, netbooks, handhelds; portable media players e.g., digital audio and/or video players; set-top boxes, gaming consoles, gaming devices, web appliances, networking devices, e.g., routers, switches, bridges, hubs; and any other suitable electronic device incorporating one or more input/output (I/O) techniques and technologies that individually or collectively facilitate interaction with the device. By way of example only, such I/O techniques and technologies include touch screens, touch pads, speech recognition technologies, motion sensor devices, keyboards and other input/cursor control devices such as a mouse, pen, trackpoint, trackball, pointers, etc.

Furthermore, while only a single device 100 is illustrated, the device 100 may also be connected/grouped locally or remotely (wired and/or wirelessly) via network 150 to other electronic devices. In a networked deployment, the device 100 may operate as a “server” or a “client” in a server-client architecture, as a “peer” device in a peer-to-peer environment, or as part of cluster/group of devices such as a so-called server “farm” or “cloud,” in any event, that individually or collectively to perform one or more features, functions and methods of the present invention.

As shown, the device 100 includes a display 108, touch screen 102 and processor/memory module 104. The display 108 incorporates a touch screen 102 which collectively provide a user interface and are communicatively coupled to the processor/memory module 104 via bus 107, which may also communicate externally through network 150 via conventional (wired or wireless) network interface (not shown).

The display 108 may be embodied, without limitation, as a liquid crystal display (LCD), a light emitting diode (LED) display, an organic light emitting diode (OLED) display, a plasma display, a projection display, or any other suitable electronic display.

The touch screen 102 can be realized as a transparent resistive touch panel, a capacitive touch panel, or other known sensing technology such as surface acoustic wave sensors, or other sonic technologies. As is known, the touch screen can be responsive to the proximity (or touching) of an input object (such as a finger, stylus, digital pen, or other object) to the surface of the screen.

In this and other embodiments, the touch screen 102 is integral with, proximate to and interposed in the line-of-sight between the user and the display 108 such that the touch screen 102 overlaps and/or overlies content displayed on the display 108. For example, if the display 108 has a substantially planar viewing area, the touch screen 102 may be aligned parallel to the planar viewing area of the display.

The processor/memory module 104 generally represents the hardware, software, and/or firmware components configured to resolve user input to the touch screen 102 to one or more user input gestures and correlate the location(s) of the input gesture(s) with location(s) of displayed objects 106 representing various content and/or applications and actions to be performed on or by the objects. As is known, the processor/memory module 104 (depending on the embodiment) may be implemented by one or a combination of general or special purpose processors, microprocessors, co-processors, graphics processors, and/or digital signal processors, along with memory 110 and other hardware, firmware and software that collectively perform the functions described herein.

As used herein, the memory 110 may include without limitation, one or one or more of random-access memory (RAM), read-only memory (ROM), an erasable programmable read-only memory (EPROM or Flash memory), a static random access memory (SRAM), hard disk, compact disc read-only memory (CD-ROM), a digital versatile disk (DVD), memory stick, buffer memory, flash memory, cache memory, a floppy disk, a mechanically encoded device such as punch-cards or raised structures in a groove having instructions recorded thereon, and any suitable combination of the foregoing centralized or distributed database storage, servers, and any other machine-readable storage medium/media (also referred to herein as a computer readable storage medium) able to retain and store computer readable instructions (the medium/media with stored computer readable instructions also referred to herein collectively as a computer program product) for execution by processor(s) or other instruction execution device. By way of example only and without limitation, the computer readable storage medium may be an electronic storage device, a magnetic storage device, an optical storage device, an electromagnetic storage device, a semiconductor storage device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The processor/memory module 104 may also include conventional logic or circuitry that is configurable to perform certain operations e.g., by software/firmware embedded within a processor, or stored in other memory devices. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

In this embodiment, the memory 110 stores computer readable instructions executable by the device 100 to provide improved techniques in accordance with the invention enabling users to use a single, uninterrupted input gesture to the touch screen 102 to contextually select an action from among available one or more actions and the objects to which the selected one or more actions can be applied. For example, one of the objects 106 can be selected via the touch screen 102, e.g., by the application of pressure by a finger, stylus, or other input object.

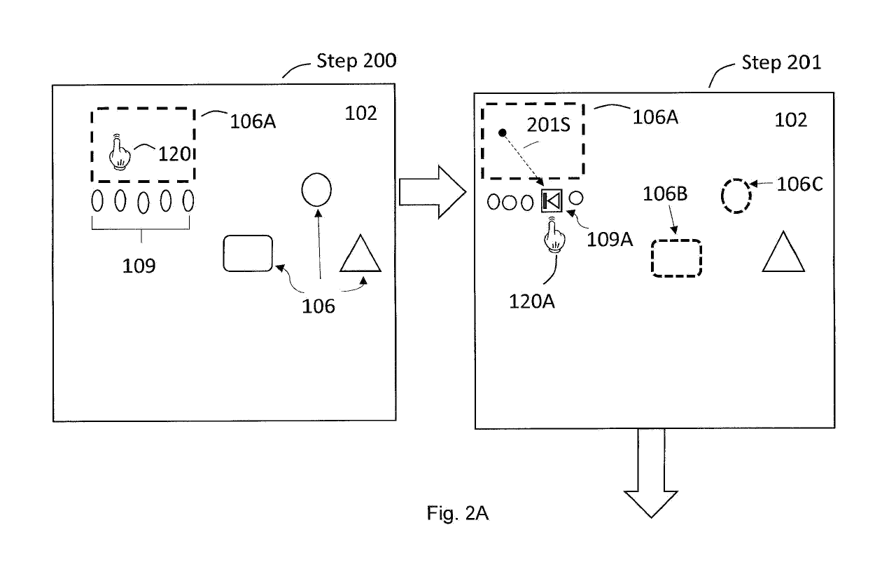

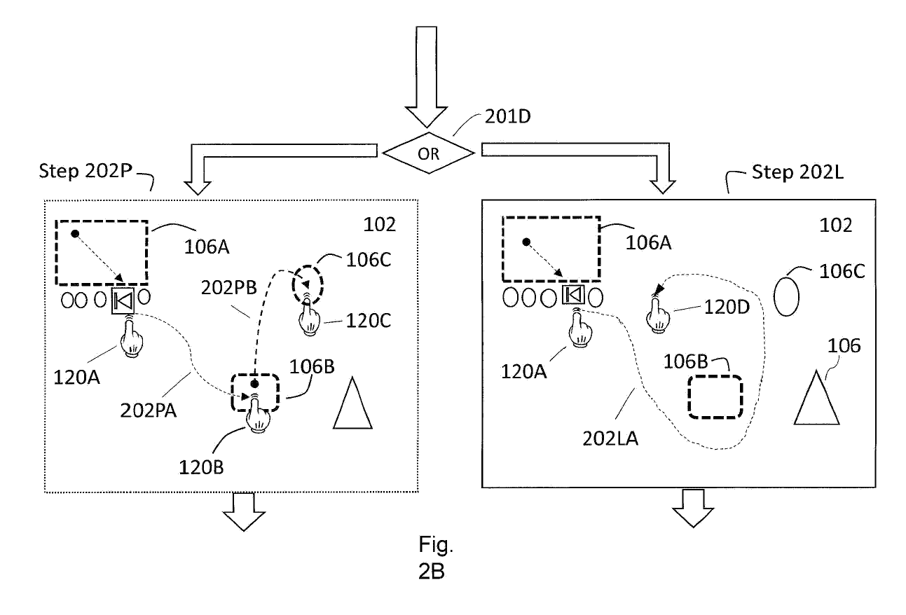

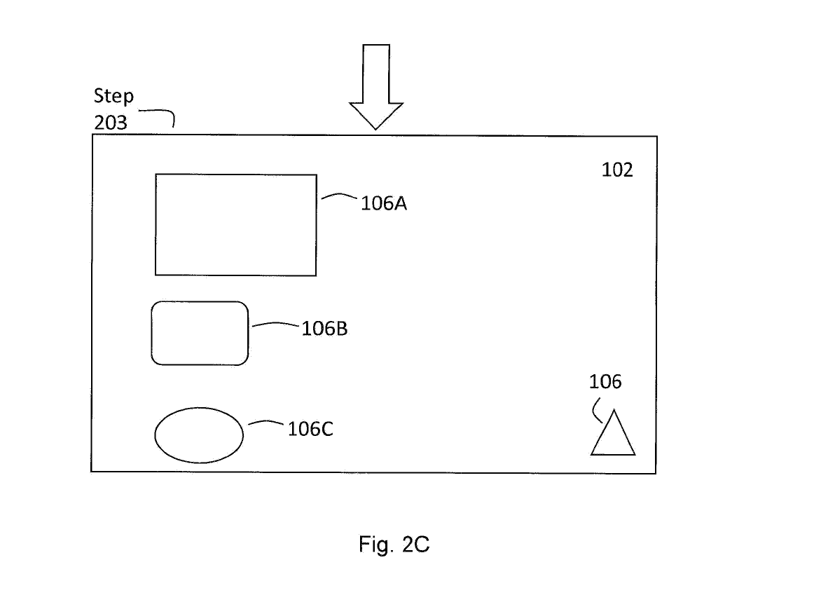

In accordance with an aspect of the present invention, such user selection preferably results in visual feedback on the display 108 of various action objects 109 representing actions available to be performed on the selected one of the objects 106. In this example, the action objects are graphical icons suggestive of the available actions. As will be described in more detail with reference to FIG. 2A, the user maintains contact between the input object and the touch screen 102 while swiping with the same input gesture over one of the displayed action objects. The detection of the action selection can result in additional device feedback indicating one or more other target objects 106 to which that action can be applied. For example, the additional feedback could highlight available objects and/or “dim” or “grey-out” unavailable target object(s). The feedback can facilitate the selection of one or more of the other target object(s) to which the selected action is desired to be applied. As will be described in more detail with reference to FIG. 2B, the user can then select the other target objects by successively swiping over them or by a “lassoing” motion around them. The input gesture can be completed by the removal of the input object from contact with the touch screen, which (when detected by the devise) results in the application of the predefined action associated with the selected action object to the selected target objects. By way of example only, it can be seen that certain embodiments of the invention may include features that reduce the number of individual operations that would otherwise be required and/or provide contextual queues that facilitate the selection and application of one of multiple available actions to multiple objects. However, the foregoing examples are not to be misconstrued as meaning either that some embodiments may not have any of the foregoing exemplary features or that some embodiments require any of the foregoing exemplary features.

In another embodiment of the present invention, the detection of the input object 120 as contacting a “blank” area of the touch screen 102 can result in device feedback displaying one or more target objects 106 and one or more action objects 109 associated with a displayed target object. The preliminary selection of a first target object and an associated action object can result in additional device feedback contextually identifying other target object(s) on which the associated action object can be invoked. The input object 120 can then be detected and tracked as forming an uninterrupted input gesture path that contextually selects the first target object and one or more other target objects on which the associated action object can be invoked. In response to the detection of the objects' selection and the completion of the input gesture path, such as by an interruption to the input gesture path, the associated action object can be invoked and its corresponding predefined action applied to the selected target objects.

It is to be understood that some embodiments of the present invention can be implemented by computer readable program instructions adapted for carrying out various features and operations in accordance with the present invention. By way of example only, computer readable program instructions include but are not limited to assembler instructions, machine instructions, machine/processor dependent instructions, microcode, firmware instructions, state-setting data, bytecode, object-code, and source code instructions, which can be interpreted/executed directly by a device or may require compilation, linkage and/or other processing before the instructions are executed. As is known, computer readable program instructions can be written in any combination of numerous programming languages and/or concepts. By way of example only, such programming languages include low-level programming languages and high-level programming languages, which can employ various procedure-oriented or object-oriented programming paradigms.

Also as is known and by way of example only, the computer readable program instructions may execute entirely on the local electronic device as a stand-alone software package, partly on the local device and partly on a remote device, or entirely on a remote device. In the latter scenario, the remote computer may be connected to the local device through a network 150, examples of which include, without limitation, a local area network (LAN), a wide area network (WAN), and the Internet, which may further involve the use of an Internet access provider or Internet service provider. Alternatively, the computer readable program instructions can be downloaded from an external computer readable storage medium or from an external computer or external storage device via a network—such as the Internet, a LAN, WAN. The network may be wired and/or wireless and include without limitation, electrical transmission cables, optical transmission fibers, wireless transmission technology, routers, firewalls, switches, gateway computers and/or edge servers.

Various aspects and features of the present invention are described herein with reference to flowchart illustrations and/or block diagrams of methods, apparatus (systems), and computer program products according to embodiments of the invention. It is to be understood that each block of the flowchart illustrations and/or block diagrams, and combinations of blocks in the flowchart illustrations and/or block diagrams, can be implemented by computer readable program instructions.

FIGS. 2A-2C depict various embodiments and features of the present invention that will now be described. Specifically with reference to FIG. 2A, in step 200, a device 100 detects contact between an input object 120—e.g., a stylus, finger, etc.—and an area of touch screen 102 corresponding to one target object 106A from among the multiple target objects 106 visible on display 108. In response to detecting such contact, the device 100 can display one or more action objects 109 (depicted in this example by the yellow ovals) each of which can correspond to a predefined action that can be applied to the target object 106A. Alternatively, the action objects 109 can more immediately display and graphically suggest the set of possible action(s) available to the preliminarily selected target object 106′. For example, one or more graphical icons 109 (such as action object 109A depicted and described with reference to step 201) can be immediately displayed in response to the detection of a preliminary selection of target object 106A. As will also be described in a more detailed example with regard to step 201, the device 100 can also provide contextual device feedback highlighting one or more other target objects 106 upon which a preliminarily selected action object be invoked.

In step 201, the input object is detected and tracked as continuing the uninterrupted input gesture path and preliminarily selecting action object 109A from among the available action objects 109 by maintaining contact and swiping touch screen 102 with input object 120 (step 200) along path 201S such that input object 120A is detected as selecting action object 109A. In this example, device feedback in the form of a graphical icon 109A representative of an “align left” action is displayed as confirmation of the preliminary selection of action object 109A. Device feedback can also be used to provide contextual guidance indicating one or more other possible target objects upon which the action object/action may (or may not) be subsequently invoked/applied. For example, the “align-left” action object 109A can be indicated as applicable to highlighted target objects 106B and 106C and/or target object 106D can be indicated as unavailable by “dimming” or “greying-out” of object 106D.

Referring now to FIG. 2B, the logical flow proceeds to branch point 201D. Depending on the embodiment, the process can proceed to step 202L or step 202P, which are provided to illustrate the use of two “wire metaphor” techniques in accordance with the present invention. By way of overview, in either of these embodiments, the input object 120A continues (from step 201) to be detected and tracked as forming an uninterrupted input gesture path by maintaining contact between the input object 120A and touch screen 102 in conjunction with device feedback that facilitates the contextual selection and invocation/application of an action object/action to selected target objects.

Step 202L depicts a first example of a wire metaphor technique, i.e., a so-called “lasso” technique adapted for the selection additional target objects in accordance with the present invention. In this example, the input object 120A is detected and tracked as continuing the uninterrupted input gesture path by maintaining contact between the input object and touch screen 102 and swiping from the location corresponding to input object 120A and encircling (or “lassoing”) an applicable target object 106B. As depicted, the device 100 detects target object 106B as selected when the input object 120A as depicted by the path 202LA is determined to have sufficiently encircled target object 106B, e.g., at the location corresponding to input object 120D. As is known, the input gesture path (e.g., path 202LA) can be displayed on the device as it is detected and tracked. Additional device feedback (such as mechanical, audible, visual or any other suitable feedback) may also be used to provide confirmation of a selection of one or more other target objects.

Step 202P depicts another example of a first example of a wire metaphor technique, i.e., a so-called “pass-through” technique adapted for the selection of one or more additional target objects in accordance with the present invention. By way of overview, the input object 120A is detected and tracked as continuing the uninterrupted input gesture path by maintaining contact between the input object 120A and touch screen 102 while swiping through (or sufficiently near) the perimeter of one or more candidate target objects. In this example, the input object is detected and tracked from input object location 120A along an uninterrupted input gesture path 202pa, to input object location 120B where it can be detected as selecting target object 106B. As depicted in this example, the uninterrupted input gesture path is detected and tracked as continuing from selected target object 106B along path 202PB where it is detected as selecting target object 106C. In some embodiments, the input object 120 may pause momentarily over a selected target object (such as target object 106B) to obtain mechanical, audible, visual or any other suitable device feedback confirming detection/selection of the target object(s).

Upon the completion of step 202L or step 202P, an exemplary process in accordance with the present invention continues to step 203 (FIG. 2C).

Referring now to FIG. 2C (step 203), depicts an example of the completion of a multi-selection contextual action path process in accordance with the present invention. In this example, the input object is removed from and is detected as no longer in contact with the touch screen 102; and in response, the “Align Left” action corresponding to action object 109A (FIG. 2A), is applied to the contextually selected target objects 106A, 106B and 106C (with reference to FIG. 28, step 202P).

By way of yet another example, the present invention includes features that facilitate the organization of objects that are dispersed across multiple display screens (not depicted) of a mobile device 100. In this example, we will assume the device 100 is currently displaying one of several available screens other than the so-called “home screen” of the device. In accordance with an embodiment of the present invention, the preliminary selection of a target object 106A (FIG. 2B, step 200) on the non-home screen of device 100 is detected and several action objects 109 are displayed in response. Next, the input object 120 is detected and tracked as commencing an uninterrupted input gesture path that preliminarily selects an available “move to another screen” action object from among the displayed action objects 109. In response, the device may highlight one or more other target objects to which the “move to another screen” action can be applied e.g., target objects 106B and/or 106C depicted in step 201. In some embodiments, the detected selection of the “move to another screen” action object 109 could result in the device 100 providing additional contextual feedback by also indicating one or more other screens of device 100 to which the target objects can be moved. In this example, we will assume that the home screen is indicated as available. Upon the detection and tracking of the input object 120 as continuing the uninterrupted input gesture path to select one or more other available target objects and an available target (home) screen and subsequent detection of completion of the input gesture, by removal of the input object 120 from touch screen 102, the “move to another screen” action is then applied to the contextually selected target objects 106, which are then moved to the home screen of device 100.

The foregoing Detailed Description and accompanying Drawings have thus illustrated the architecture, functionality, and operation of various embodiments of devices, methods, and computer program products in accordance with of the present invention. In this regard, each block in the flowchart or block diagrams may represent a module, segment, or portion of computer executable instructions for implementing the corresponding logical function(s). It is understood that the functions noted in a given block (or step) may occur in a different order from the examples described in the Detailed Description and Drawings. For example, two blocks shown in succession may, in fact, be executed substantially concurrently (and vice versa), or the blocks may sometimes be executed in the reverse order, depending upon the functionality involved. It is also understood that a block (and/or combination of blocks) of the block diagrams and/or flowcharts can be implemented by special purpose hardware-based systems and/or combinations of such hardware with computer instructions that perform the specified functions or process steps.

Now that various features and aspects of the invention have been described, these and other features, variations, modifications, additions, improvements and aspects will be apparent to one of ordinary skill in the art, all of which are understood to be within the scope of the following claims.

What is claimed is:

1. A computer implemented method of using an uninterrupted gesture path to contextually apply an action to objects on a display of an electronic device, said computer implemented method comprising:
concurrently displaying objects on the display, wherein said objects include target objects associated with at least one action object that when invoked will apply a predefined action to one or more selected associated target objects;
detecting an input to a first associated target object, in response to said concurrently displaying objects on the display;
displaying at least one action object, in response to said detecting an input to a first associated target object;
detecting the input as selecting a displayed action object and tracking the input as an uninterrupted input gesture path;
providing contextual feedback to indicate one or more other target objects that can be selectably associated with the displayed action object, in response to said selecting the displayed action;
detecting and tracking the uninterrupted input gesture path as selecting said one or more other target objects, in response to said providing contextual feedback to indicate one or more other target objects that can be selectably associated with the displayed action object;
detecting an interruption of the input gesture path; and
invoking the displayed action object and applying the predefined action to selected associated target objects, in response to said detecting an interruption of the input gesture path.

2. The computer implemented method of claim 1, wherein the predefined action is selected from a group consisting of grouping, moving, arranging, aligning, distributing, joining, and applying a theme.

3. The computer implemented method of claim 1, wherein selecting said action objects and said target objects further comprises lassoing said action objects and said target objects with an input object.

4. The computer implemented method of claim 1, wherein said indicating one or more other target objects that can be selectably associated with the displayed action object, further comprises emphasizing said one or more other target objects on the display.

5. The computer implemented method of claim 1, wherein said displaying at least one action object further comprises:
displaying multiple action objects as generic shapes and tracking the uninterrupted gesture path as traversing a generically shaped action object; and
displaying the predefined action associated said generically shaped action object, in response to said traversing.

6. A computer program product for using an uninterrupted gesture path to contextually apply an action to objects on a display of an electronic device, the computer program product comprising a computer-readable storage medium having program code embodied therewith, wherein the computer readable storage medium is not a transitory signal per se, the program code executable by at least one processor to cause the electronic device to perform a method comprising:
concurrently displaying objects on the display, wherein said objects include target objects associated with at least one action object that when invoked will apply a predefined action to one or more selected associated target objects;
detecting an input as selecting a first target object associated with said at least one action object, in response to said concurrently displaying objects on the display;
displaying at least one action object, in response to said detecting an input as selecting a first associated target object;
detecting and tracking the input as an uninterrupted input gesture path and selecting a first action object, in response to said displaying at least one action object;
providing contextual feedback to indicate one or more other target objects that can be selectably associated with the first action object, in response to said selecting a first action object;
detecting and tracking the uninterrupted input gesture path as selecting said one or more other target objects, in response to said providing contextual feedback to indicate one or more other target objects;
detecting an interruption of the input gesture path, in response to said selecting said one or more other target objects; and
invoking the displayed action object and applying the predefined action to selected target objects, in response to said detecting said interruption of the input gesture path.

7. The computer program product of claim 6, wherein the predefined action is selected from a group consisting of: grouping, moving, arranging, aligning, distributing, joining, and applying a theme.

8. The computer program product of claim 6, wherein said detecting and tracking the uninterrupted gesture path further comprises: lassoing selected action objects and associated target objects with an input object.

9. The computer program product of claim 6, wherein said indicating one or more other target objects that can be selectably associated with the displayed action object, further comprises emphasizing said one or more other target objects on the display.

10. The computer program product of claim 6, wherein said displaying at least one action object further comprises:
displaying multiple action objects as generic shapes and tracking the uninterrupted gesture path as traversing a generically shaped action object; and
displaying the predefined action associated said generically shaped action object, in response to said traversing.

11. A mobile device for contextually applying an uninterrupted input gesture path to invoke a predefined action on at least two target objects selected from among a plurality of concurrently displayed objects, said device comprising:
a display;
an interface communicatively coupled to said display;
a processor communicatively coupled to a memory and to the interface, wherein said memory stores programming instructions readable and executable by the processor, comprising:
input object detection means for detecting an input object as associated with a first target object on said display and responsively displaying at least one action object associated with the first target object;
input object tracking means, coupled to said input object detection means, for tracking the input object as selecting a displayed action object by an uninterrupted input gesture path;
contextual device feedback means, coupled to said input object tracking means, for indicating one or more other target objects that can be associated with a selected action object;
said input object tracking means further adapted for detecting and tracking the uninterrupted gesture path as selecting at least one of said other target objects;
input gesture path interruption detection means, coupled to said input object tracking means, for detecting an interruption of the input gesture path; and
action invocation means, coupled to said input gesture path interruption detection means, for invoking the predefined action on the first target object and the at least one of said other target objects.

12. The mobile device of claim 11, wherein the predefined action is selected from a group consisting of grouping, moving, arranging, aligning, distributing, joining, and applying a theme.

13. The mobile device of claim 11, wherein said input object tracking means for detecting and tracking the uninterrupted gesture path input further comprises lassoing means for selecting action objects and associated target objects with an input object.

14. The mobile device of claim 11, wherein said contextual device feedback means further comprises means for emphasizing said one or more other target objects on the display.

15. The mobile device of claim 11, wherein said input object detection means further comprises:
means for displaying multiple action objects as generic shapes and tracking the uninterrupted gesture path as traversing a generically shaped action object; and
means for displaying the predefined action associated said generically shaped action object, in response to traversing the generically shaped action object.
